(19) United States
(12) Patent Application Publication
(10) Pub. No.: US 2002/0107797 A1
(43) Pub. Date: Aug. 8, 2002

(54) Electronic remittance transfer from a merchant's smart card to a consumer loyalty smart card identified by a transaction authorization code

(76) Inventor: Pierre Michel Combaluzier, Montreal (CA)

Correspondence Address: BIRCH STEWART KOLASCH & BIRCH, PO BOX 747, FALLS CHURCH, VA, 22040-0747, US

(21) Appl. No.: 09/734,619

(22) Filed: Dec. 13, 2000

(51) Int. Cl. G06F 17/60

(52) U.S. Cl. 705/41; 705/14

(57) ABSTRACT

A method of transferring a cash remittance from a merchant's smart card to a customer loyalty smart card following a bank card transaction that has been approved, through an authorization code, by a financial institution having issued the bank card. Both the amount of the transaction and the authorization code are entered through a keyboard. The amount of the remittance is calculated in relation to the amount of the transaction, and the calculated remittance is transferred from the merchant's smart card to the customer loyalty smart card. Finally, the transfer of the remittance comprises associating the remittance to the authorization code. Association of the remittance to the authorization code enables detection of a remittance which does not correspond to the amount of the corresponding transaction which indicates either an error upon entering the amount of the transaction or an attempted fraud.

### BACKGROUND OF THE INVENTION

1. Field of the Invention

The present invention relates to the transfer of remittances from a merchant's smart card to a consumer loyalty smart card.

2. Brief Description of the Prior Art

The prior art has proposed many systems for granting rebates, cash values, credit, discounts, coupons, etc. through the use of smart cards, credit cards, debit cards, customer loyalty cards, security features cards, etc. Examples of these prior art systems are given in the following patent documents:

| | | |
|---|---|---|
| U.S. Pat. No. 6 105 865 | (Hardesty) | 08/22/2000 |
| U.S. Pat. No. 6 067 526 | (Powell) | 05/23/2000 |
| U.S. Pat. No. 6 055 509 | (Powell) | 04/25/2000 |
| U.S. Pat. No. 6 039 244 | (Finsterwald) | 03/21/2000 |
| U.S. Pat. No. 6 014 635 | (Harris et al.) | 01/11/2000 |
| U.S. Pat. No. 5 918 211 | (Sloane) | 06/29/1999 |
| U.S. Pat. No. 5 729 693 | (Holda-Fleck) | 03/07/1998 |
| US Re 36 116 | (McCarthy) | 02/23/1999. |

A drawback of most of the above prior art systems is the lack of features for authenticating the recorded operations and transactions and provide fraud-proof systems that can be fully monitored, controlled and supervised.

### SUMMARY OF THE INVENTION

More specifically, in accordance with the present invention, there is provided a method of transferring a remittance from a merchant's smart card to a customer loyalty smart card following a bank card transaction that has been approved, through an authorization code, by a financial institution having issued the bank card. This method comprises entering the authorization code, and conveying the remittance from the merchant's smart card to the customer loyalty smart card. Conveying of the remittance itself comprises associating the remittance to the authorization code.

Association of the remittances from the merchant's smart card to the consumer loyalty smart cards by means of the transaction authorization code enables safe correlation between the data related to the remittances and the data related to the transactions for many purposes including:

detecting eventual frauds;

compensating for remittances;

producing statistics on customer loyalty programs;

follow-up of customer loyalty campaigns; and

granting bonus advantages to clients having customer loyalty cards depending on the frequency of use of that card.

According to preferred embodiments of the remittance transfer method:

the bank card is one of the following cards:

a credit card;

a debit card; or

any other customer's card usable to complete a transaction between a merchant and the customer and requiring an authorization code from the financial institution having issued the card to approve the transaction;

entering the authorization code comprises entering the authorization code in an electronic remittance transfer device; and

the remittance transfer method further comprises:

inserting the merchant's smart card in the electronic remittance transfer device;

connecting an integrated circuit of the merchant's smart card to the electronic remittance transfer device;

inserting the customer loyalty smart card in the electronic remittance transfer device; and

connecting an integrated circuit of the customer loyalty smart card to the electronic remittance transfer device.

According to another preferred embodiment:

the remittance transfer method further comprises entering an amount of the transaction and calculating, in the merchant's smart card, an amount of the remittance in relation to the amount of the transaction and in accordance with a predetermined remittance calculating function; and

calculation of the amount of the remittance comprises consulting statistical remittance data stored in the customer loyalty smart card to take the statistical remittance data into consideration upon calculating the amount of the remittance.

According to a further preferred embodiment:

the remittance transfer method further comprises entering an amount of the transaction, and conveying the remittance comprises:

debiting the remittance from the merchant's smart card;

crediting the remittance to the customer loyalty smart card; and

storing in the customer loyalty smart card the following data related to each remittance: the date and time; an identification code of a merchant's payment terminal through which the transaction has been approved by the financial institution; the amount of the transaction; the authorization code; and the amount of the remittance;

the remittance transfer method further comprises recovering and storing in a remittance journal the data related to each remittance, stored in the customer loyalty smart card and including:

the date and time of the remittance;

the identification code of the merchant's payment terminal;

the amount of the transaction;

the authorization code; and

the amount of the remittance;

the remittance transfer method further comprises storing in a transaction journal and for each transaction: the date and time of the transaction; the identification code of the merchant's payment terminal; the amount of the transaction; and the authorization code; and comparing the data related to the transactions stored in the transaction journal with the data related to the remittances stored in the remittance journal for detecting frauds; and

detection in the transaction and remittance journals of a transaction having the same authorization code and payment terminal identification code but different amounts of transaction indicates either an error upon entering the amount of the transaction in the electronic remittance transfer device or an attempted fraud.

The present invention further relates to a system for transferring a remittance from a merchant's smart card to a customer loyalty smart card following a bank card transaction that has been approved, through an authorization code, by a financial institution having issued the bank card. This system comprises: means for entering the authorization code; and means for conveying the remittance from the merchant's smart card to the customer loyalty smart card. The remittance conveying means comprises means for associating the remittance to the authorization code.

The present invention further relates to a system for transferring a remittance from a merchant's smart card to a customer loyalty smart card following a bank card transaction that has been approved, through an authorization code, by a financial institution having issued the bank card. This system comprises: a keyboard for entering the authorization code; and a remittance transfer unit connected to the keyboard, interposed between the merchant's smart card and the customer loyalty smart card and through which the remittance from the merchant's smart card is transferred to the customer loyalty smart card. This remittance transfer unit itself comprises a remittance-to-authorization code associating means.

According to preferred embodiments:

the keyboard forms part of an electronic remittance transfer device, and the electronic remittance transfer device further comprises: a merchant's smart card receiving means having electric contacts for connection to external electric contacts of an integrated circuit of the merchant's smart card; and a customer loyalty smart card receiving means having electric contacts for connection to external electric contacts of an integrated circuit of the customer loyalty smart card;

an amount of the transaction is entered through the keyboard, and the remittance transfer system further comprises, in the merchant's smart card, a calculator of an amount of the remittance in relation to the amount of the transaction, this calculator incorporating a predetermined remittance calculating function;

the customer loyalty smart card comprises a statistical remittance data memory in which statistical data about the remittances transferred to the customer loyalty smart card is stored, and the electronic remittance transfer device comprises a statistics reader module for interposition between the remittance amount calculator and the statistical remittance data memory, wherein the remittance amount calculator consults the data about the remittances stored in the statistical remittance data memory through this statistics reader module;

the an amount of the transaction is entered through the keyboard, the merchant's smart card comprises a merchant's electronic wallet, the customer loyalty smart card comprises a consumer's electronic wallet, the remittance transfer unit comprises, between the merchant's electronic wallet and the consumer's electronic wallet, a remittance transfer module fulfilling the function of debiting the remittance from the merchant's electronic wallet and crediting said remittance to the customer's electronic wallet upon said transfer of the remittance, the merchant's smart card comprises a memory of an identification code of a merchant's payment terminal through which the transaction has been approved by the financial institution, and a storing circuit having access to given data related to each remittance and including a memory of the given data in the customer loyalty smart card, wherein the given data comprises: the date and time of the remittance; the identification code of the merchant's payment terminal; the amount of the transaction; the authorization code; and the amount of the remittance;

the remittance transfer system further comprises a communication network to recover and store in a remittance journal the data related to each remittance, stored in the customer loyalty smart card and including: the date and time of the remittance; the identification code of the merchant's payment terminal; the amount of the transaction; the authorization code; and the amount of the remittance;

the remittance transfer system further comprises:

a transaction journal storing, for each transaction:

the date and time of the transaction;

the identification code of the merchant's payment terminal;

the amount of the transaction; and

the authorization code; and

a data comparing computer connected to both the transaction and remittance journals and comparing the data related to the transactions stored in the transaction journal with the data related to the remittances stored in the remittance journal in view of detecting frauds;

the data comparing computer comprises a detector of a transaction having in the transaction and remittance journals the same authorization code and payment terminal identification code but different amounts of transaction, and an indicator of either an error upon entering the amount of the transaction through the keyboard of the electronic remittance transfer device or an attempted fraud, activated by the detector upon detection of a transaction having in the transaction and remittance journals the same authorization code and payment terminal identification code but different amounts of transaction.

The above and other objects, advantages and features of the present invention will become more apparent upon reading of the following non-restrictive description of a preferred embodiment thereof, given by way of example only with reference to the accompanying drawings.

### BRIEF DESCRIPTION OF THE DRAWINGS

In the appended drawings:

FIG. 1 is a schematic flow chart of the preferred embodiment of the method according to the invention, for transferring a remittance from a merchant's smart card to a customer loyalty smart card;

FIG. 2 is a perspective view of a two-flap folder, in open position, in which the electronic remittance transfer device is mounted, in which a customer's bank card is being placed and in which a duplicate transaction receipt has been placed;

FIG. 3 is a perspective view of the two-flap folder of FIG. 2, in open position, in which the electronic remittance transfer device is mounted, in which the customer's bank card has been placed, in which a duplicate transaction receipt has been placed, and in which the merchant's smart card is being inserted in the electronic remittance transfer device;

FIG. 4 is a perspective view of the two-flap folder of FIGS. 2 and 3, in open position, in which the electronic remittance transfer device is mounted, in which the customer's bank card has been placed, in which a duplicate transaction receipt has been placed, in which the merchant's smart card has been inserted in the electronic remittance transfer device, and in which the customer loyalty smart card is being inserted in the electronic remittance transfer device; and

FIG. 5 is a perspective view of the two-flap folder of FIGS. 2, 3, 4 and 5, in open position, in which the electronic remittance transfer device is mounted, in which the customer's bank card has been placed, in which a duplicate transaction receipt has been placed, in which the merchant's smart card has been inserted in the electronic remittance transfer device, and in which the customer loyalty smart card has been inserted in the electronic remittance transfer device; and

FIG. 6 is a block diagram of the merchant's smart card, the electronic remittance transfer device and the customer loyalty smart card.

### DETAILED DESCRIPTION OF THE PREFERRED EMBODIMENT

A preferred embodiment of the present invention will now be described. Although this preferred embodiment will be described in relation to a restaurant, it should be kept in mind that the same concept can be applied to any merchant other than a restaurateur.

Also, although this preferred embodiment will be described in relation to a Mondex™ platform, it should be kept in mind that the present invention could obviously be applied to any other platform. Examples of other platforms are Java, Visa Open Platform, Open TV, Windows Smart Card, Cyweb, etc.

The preferred embodiment will now be described with reference to the appended drawings. The same elements are identified by the same references in the different figures of drawing

1^{st} Operation:

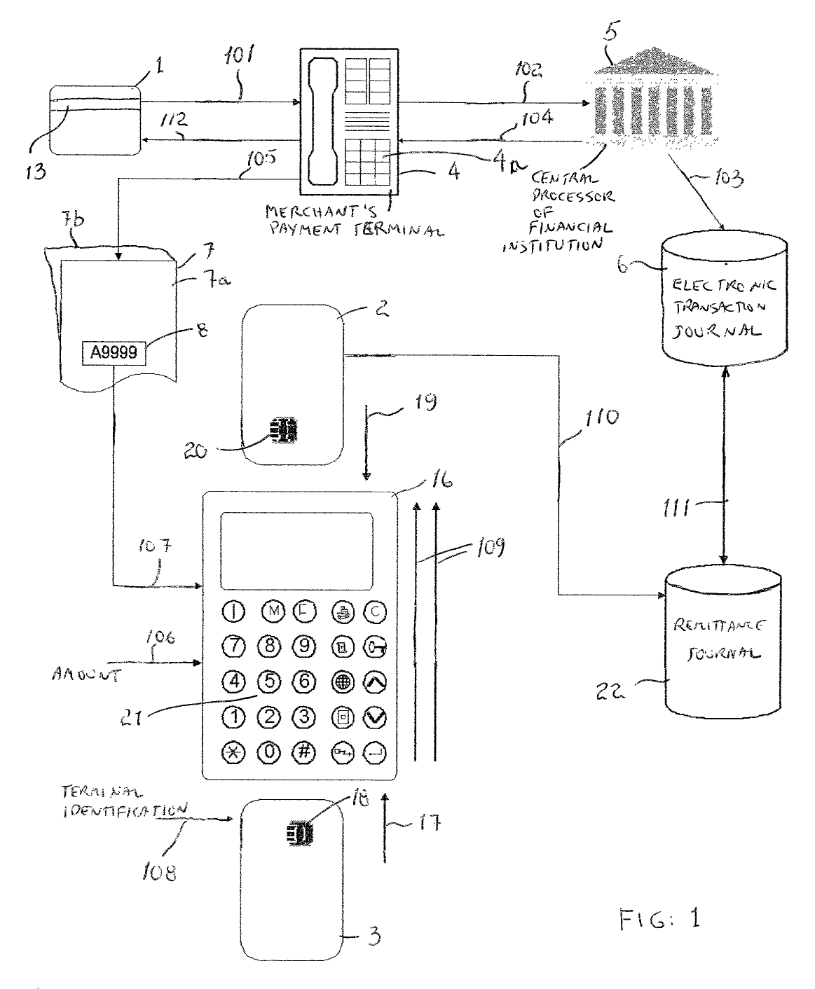

Card 1 (FIG. 1) is a conventional customer's bank card such as a credit card, a debit card, and any other card usable to complete a transaction between a merchant and the customer and requiring an authorization code from the financial institution having issued the card to approve the transaction. Bank card 1 comprises, for example, a magnetic stripe 13. As well known to those of ordinary skill in the art, a transaction between a customer (cardholder) and a merchant is made as follows:

The magnetic stripe 13 of card 1 is read through the magnetic card reader (not shown) of a merchant's payment terminal 4 (see arrow 101 in FIG. 1). In the case of a credit card, terminal 4 is an automated authorization terminal. In the case of a debit card, terminal 4 is a debit terminal. Terminal 4 is used by merchants in their stores, including restaurants, to communicate electronically with the financial institution having issued the customer's bank card 1 to obtain approval, electronically, from this financial institution of bank card transactions.

The amount of the transaction is entered through a keyboard 4a of terminal 4 by the merchant.

The information read from the magnetic stripe and the information about the amount of the transaction are sent by the merchant's terminal 4 to a central processor 5 of the merchant's financial institution (see arrow 102 in FIG. 1).

When the transaction is approved and authorized by the financial institution, this transaction is recorded in an electronic transaction journal 6 (see arrow 103 of FIG. 1) and the central processor 5 of the financial institution generates an authorization code normally consisting of a series of 4 to 6 digits. Of course, it is within the scope of the present invention to use any other types of authorization codes, including alphanumeric codes. More specifically, the authorization code, the amount of the transaction, the date and time of the transaction and an identification number (code) of the merchant's payment terminal 4 are recorded in the transaction journal 6 in relation to each transaction.

2^{nd} Operation:

The result of the authorization request along with the authorization code is returned to the merchant's terminal 4 (see arrow 104 of FIG. 1). Terminal 4 then prints in duplicate a transaction receipt 7 including the authorisation code 8, a first copy 7a for the customer and a second copy 7b for the merchant (see arrow 105 in FIG. 1).

Terminal 4 is otherwise well known to those of ordinary skill in the art and, accordingly, will not be further described in the present specification.

3^{rd} Operation:

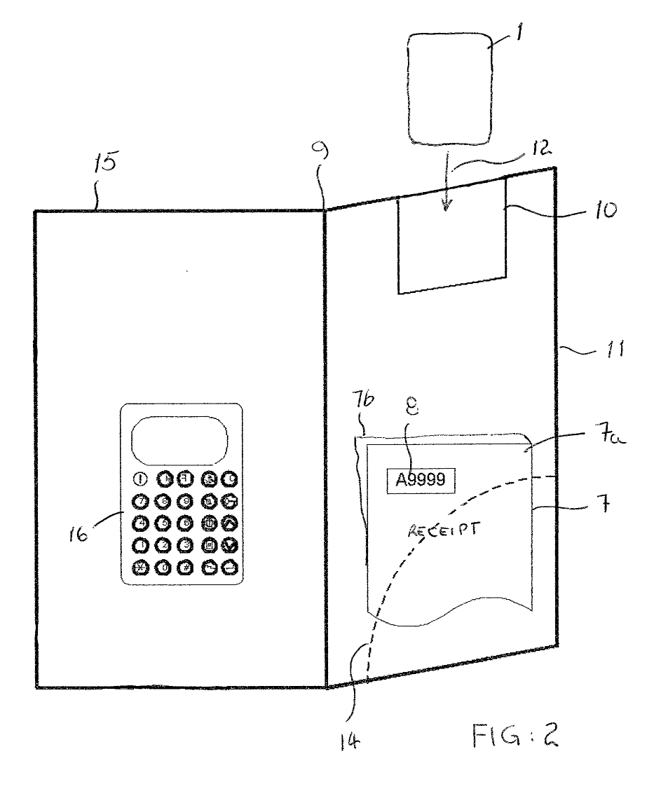

As illustrated in FIG. 2, a folder 9 is opened and the bank card 1 is placed in a top, central pocket 10 made of transparent plastic material and located on the inner side of a right flap 11 of this folder 9 (see arrow 12 in FIG. 2 and arrow 112 in FIG. 1).

The duplicate receipt 7 is placed, in turn, in a bottom pocket 14 also made of transparent plastic material so as to expose the authorization code 8. Again, the bottom pocket 14 is located on the inner side of the right flap 11.

As a non limitative example, the folder 9 is formed of left 15 and right 11 flaps both made of padded plastic material. Folder 9 will allow the waiter to carry the duplicate receipt 7 and the card 1, as well as an electronic remittance transfer devicel6 to be described later.

4^{th} Operation:

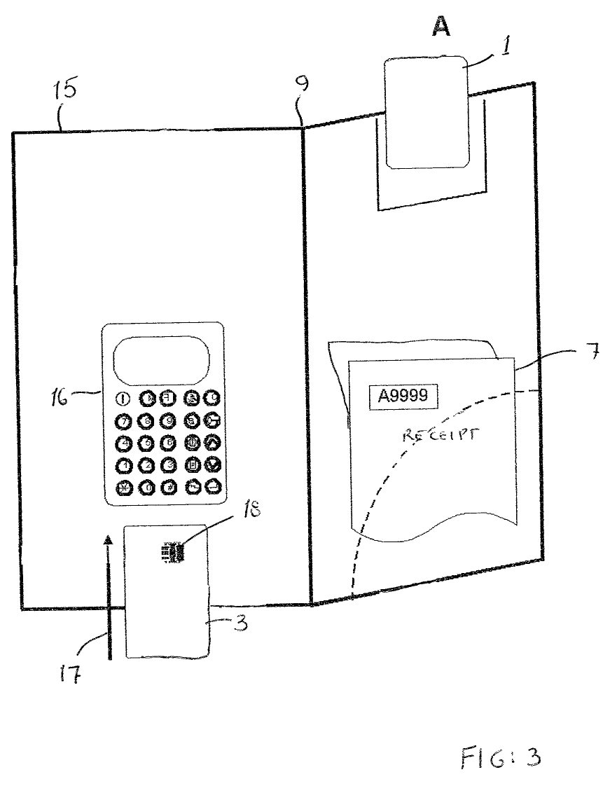

Card 3 is a merchant's smart card associated to the restaurant. As a non limitative example shown FIG. 3, card 3 is a merchant's Mondex™ smart card, i.e. a credit-card-type electronic card comprising an integrated circuit which contains a microprocessor programmed to perform various functions when inserted in a suitable terminal. Because of its data storage capacity, smart cards provide a variety of new possibilities for information storage, processing and transmission not available through other technologies.

Merchant's smart card 3 is inserted as shown in FIG. 3 into a bottom slot (not shown) of the electronic remittance transfer device 16 (see arrow 17). Alternatively, smart card 3 can be permanently inserted in the device 16. Of course, the electronic remittance transfer device 16 comprises suitable contacts (not shown) for connection to the external contacts 18 of the integrated circuit of card 3.

The electronic cash transfer device 16 is mounted in any suitable manner on the inner side of the left flap 15 of the folder 9, as shown in FIGS. 2-5. However, it should be kept in mind that the device 6 has to be periodically removed from the flap 15 to replace the batteries. When the merchant's smart card 3 is permanently inserted inside the device 16 periodic removal of the device 16 from the flap 15 will also enable access to the card 3 for replacement of that card or injection of new funds therein.

In the case of a restaurant, the waiter then takes the folder 9 as illustrated in FIG. 3 to the customer's table.

5^{th} Operation:

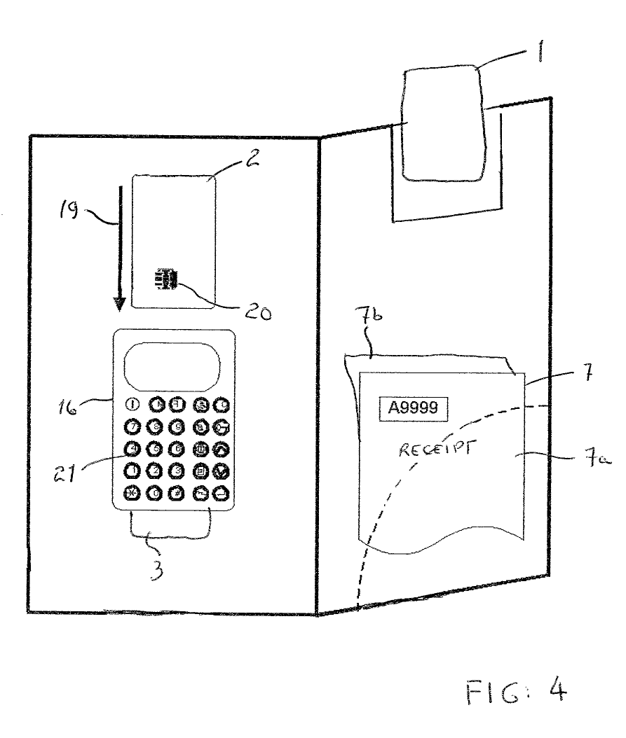

Card 2 is a customer loyalty card associated to a particular customer. As can be seen in FIG. 4, card 2 is a smart card, i.e. a credit-card-type electronic card comprising an integrated circuit which contains a microprocessor programmed to perform various functions when inserted in a suitable terminal.

As shown in FIG. 4, the waiter inserts customer loyalty card 2 into a top slot (not shown) of the electronic remittance transfer device 16 (see arrow 19). Of course, the top slot of device 16 comprises suitable contacts (not shown) for connection to the external contacts 20 of the integrated circuit of card 2.

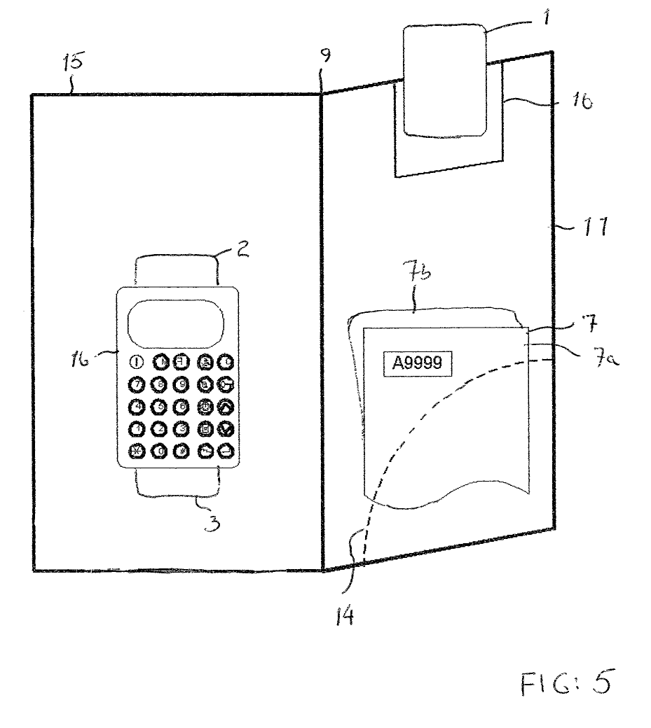

Following the 4^{th} operation, the scheme of FIG. 5 is obtained.

6^{th} Operation:

The waiter manually enters through the keyboard 21 of the electronic remittance transfer device 16 both the amount of the transaction (see arrow 106 in FIG. 1) and the authorization code 8 appearing on the receipt 7 (see arrow 107 in FIG. 1).

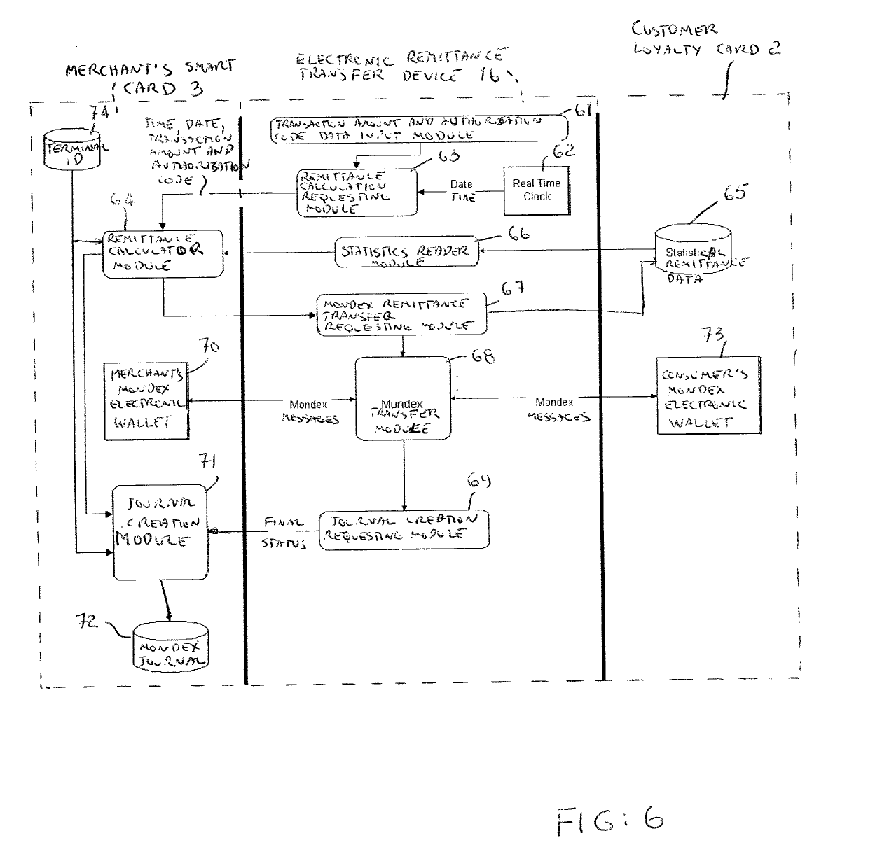

Entering of the amount of the transaction and the authorization code is made through a transaction amount and authorisation code data input module 61 of the electronic remittance transfer device 16 as shown in FIG. 6.

7^{th} Operation:

Still referring to FIG. 6, the electronic remittance transfer device 16 comprises a real time clock 62. The time and date from the real time clock 62 as well as the amount of the transaction and authorization code 8 from the input module 61 are supplied to a remittance calculation requesting module 63.

Requesting module 63 then supplies the amount of the transaction, the authorization code, the time and the date to an electronic remittance calculator module 64 of the merchant's smart card 3, and requests calculator module 64 to calculate the amount of an electronic remittance from the amount of the transaction. In this preferred embodiment, the remittance is an electronic cash remittance representative of money. It is also within the scope of the present invention to use other types of remittance such as points, miles, etc.

Calculator module 64 of the merchant's smart card 3 then calculates the remittance in relation to the amount of the transaction in accordance with a predetermined remittance calculating function. Prior to calculation of the amount of the remittance, calculator module 64 consults the statistical remittance data recorded in the customer loyalty smart card 2 to take into consideration these data stored in memory 65 of the customer loyalty card 2 through a statistics reader module 66 of the electronic remittance transfer device 16. In particular, memory 65 receives and store bonus tokens which increase the amount of the electronic remittances. Calculator module 64 will raise the amount of the remittance if the statistical remittance data from memory 65 indicates a large number of electronic remittances itself indicating a great loyalty of the consumer.

Although in this preferred embodiment the amount of the remittance is calculated in relation to amount of the transaction, it is within the scope of the present invention to grant a remittance of given amount for each transaction. Of course, any other scheme could be implemented.

The calculator module 64 then transfers to a Mondex™ remittance transfer requesting module 67 the amount of the calculated remittance, the amount of the transaction, the authorization code, the time and date of the remittance from clock 62, and the identification number (code) of the merchant's payment terminal 4 as stored in a memory 74 of merchant's card 3 (see arrow 108 in FIG. 1). A Mondex™ transfer module 68 is then requested by module 67 to convey the electronic remittance calculated in module 64 by debiting the remittance from a merchant's Mondex™ electronic wallet included in merchant's smart card 3 and crediting this remittance to a consumer's Mondex™ electronic wallet of loyalty smart card 2 (see arrow 109 in FIG. 1).

Simultaneously the following information is conveyed from module 67 and recorded in the memory 65 of customer loyalty card 2 in association with the remittance credited to wallet 73 (see arrows 109 in FIG. 1):

the date and time of the remittance from clock 62;

the identification number (code) of the merchant's payment terminal 4;

the amount of the transaction;

the authorization code; and

the amount of the remittance.

The memory 65 is in fact a Mondex™ journal of the electronic remittance transfer operations (of course, it is within the scope of the present invention to use another type of journal of the electronic remittance transfer operations) including the memory space and logic required to receive and store the above defined data related to the transferred remittances, and the memory space and logic required to receive bonus tokens from module 67 and to store these bonus tokens in view of increasing the electronic cash remittances calculated by the calculator module 64.

To perform the above remittance transfer, the merchant's smart card 3 has a Mondex™ electronic wallet 70 with a credit balance to grant electronic remittances and the configuration items required to conduct remittance transfers toward a consumer's Mondex™ electronic wallet 73 (of course, it is within the scope of the present invention to use another type of electronic wallets).

In the same manner, the consumer loyalty smart card 2 includes a Mondex™ electronic wallet 73 with the configuration items required to receive electronic remittance transfers from the merchant's Mondex™ electronic wallet 70 (of course, it is within the scope of the present invention to use another type of electronic wallets) and to conduct transactions, in particular purchases, using the transferred remittances.

The merchant's smart card 3 further comprises a Mondex™ journal 72 of the electronic remittance operations (of course, it is within the scope of the present invention to use another type of journal of the electronic remittances). After the transfer of the electronic remittance has been completed by the transfer module 68 and upon request from a journal creation requesting module 69 of the electronic remittance transfer device 16, a journal creation module 71 of the merchant's smart card 3 stores in the journal 72 the following information:

the identification number (code) of the retailer's payment terminal as stored in memory 74;

a number or code of identification of the merchant and the merchant's banner as stored in memory 74;

the amount of the transaction between the customer and the merchant from module 64;

the authorization code of the transaction from calculator module 64;

the time and date from calculator module 64; and

the amount of the remittance.

Although this is not shown, the merchant's smart card 3 and the consumer loyalty card 2 both store security information required to make the process safe such as secret codes, passwords, cryptographic keys, etc.

Via a medium such as a bank network, Internet, etc., the information about the transfer of remittances stored in the memories such as 65 of the customers' loyalty smart cards such as 2 is recovered and stored in a remittance journal 22 (see arrow 110 of FIG. 1).

More specifically, the remittance journal 22 stores, for each electronic remittance, the following information:

the identification number (code) of the merchant's payment terminal 4;

the amount of the transaction between the merchant and the customer;

the authorization code allocated to the transaction;

the amount of the remittance; and

the date and time of the remittance transfer.

A computer system compares the data stored in the electronic transaction journal 6 with the data stored in the remittance journal 22 (see arrows 111 of FIG. 1) for the purpose of:

detecting eventual frauds;

compensating for remittances;

producing statistics on customer loyalty programs;

follow-up of customer loyalty campaigns; and

granting bonus advantages to clients having customer loyalty cards depending on the frequency of use of that card.

Just a word to mention that upon comparison of the journals 6 and 22, the following fields enable identification of the transactions:

indentification code of the merchant's payment terminal;

amount of the transaction between the merchant and the consumer; and

authorization code of this transaction.

It should be pointed out that a transaction having in the journals 6 and 22 the same authorization code and payment terminal identification code but different transaction amounts indicates an error upon entering the amount of the transaction through the keyboard 21 of the electronic remittance transfer device 16. Too high a transaction amount may be indicative of an attempted fraud, with collusion between the waiter or cashier and the customer.

Although the present invention has been described hereinabove by way of a preferred embodiment thereof, this embodiment can be modified at will, within the scope of the appended claims, without departing from the spirit and nature of the subject invention.

What is claimed is:

1. A method of transferring a remittance from a merchant's smart card to a customer loyalty smart card following a bank card transaction that has been approved, through an authorization code, by a financial institution having issued the bank card, comprising:
entering the authorization code; and
conveying the remittance from the merchant's smart card to the customer loyalty smart card, wherein conveying of the remittance comprises associating the remittance to the authorization code.

2. A remittance transfer method as defined in claim 1, wherein the bank card is one of the following cards:
a credit card;
a debit card; or
any other customer's card usable to complete a transaction between a merchant and the customer and requiring an authorization code from the financial institution having issued the card to approve the transaction.

3. A remittance transfer method as defined in claim 1, wherein:
entering the authorization code comprises entering the authorization code in an electronic remittance transfer device;
the remittance transfer method further comprises:
inserting the merchant's smart card in the electronic remittance transfer device;
connecting an integrated circuit of the merchant's smart card to the electronic remittance transfer device;
inserting the customer loyalty smart card in the electronic remittance transfer device; and
connecting an integrated circuit of the customer loyalty smart card to the electronic remittance transfer device.

4. A remittance transfer method as defined in claim 1, further comprising:
entering an amount of the transaction; and
calculating, in the merchant's smart card, an amount of the remittance in relation to the amount of the transaction and in accordance with a predetermined remittance calculating function.

5. A remittance transfer method as defined in claim 4, wherein calculation of the amount of the remittance comprises consulting statistical remittance data stored in the customer loyalty smart card to take said statistical remittance data into consideration upon calculating said amount of the remittance.

6. A remittance transfer method as defined in claim 1, further comprising entering an amount of the transaction, wherein conveying the remittance comprises:
debiting said remittance from the merchant's smart card;
crediting said remittance to the customer loyalty smart card; and
storing in the customer loyalty smart card the following data related to each remittance:
the date and time;
an identification code of a merchant's payment terminal through which the transaction has been approved by the financial institution;
the amount of the transaction;
the authorization code; and
the amount of the remittance.

7. A remittance transfer method as defined in claim 6, further comprising recovering and storing in a remittance journal the data related to each remittance, stored in the customer loyalty smart card and including:
the date and time of the remittance;
the identification code of the merchant's payment terminal;
the amount of the transaction;
the authorization code; and
the amount of the remittance.

8. A remittance transfer method as defined in claim 7, further comprising:
storing in a transaction journal and for each transaction:
the date and time of the transaction;
the identification code of the merchant's payment terminal;
the amount of the transaction; and
the authorization code; and
comparing the data related to the transactions stored in the transaction journal with the data related to the remittances stored in the remittance journal for detecting frauds.

9. A remittance transfer method as defined in claim 8, wherein detection in the transaction and remittance journals of a transaction having the same authorization code and payment terminal identification code but different amounts of transaction indicates either an error upon entering the amount of the transaction in the electronic remittance transfer device or an attempted fraud.

10. A system for transferring a remittance from a merchant's smart card to a customer loyalty smart card following a bank card transaction that has been approved, through an authorization code, by a financial institution having issued the bank card, comprising:
means for entering the authorization code; and
means for conveying the remittance from the merchant's smart card to the customer loyalty smart card, wherein the remittance conveying means comprises means for associating the remittance to the authorization code.

11. A system for transferring a remittance from a merchant's smart card to a customer loyalty smart card following a bank card transaction that has been approved, through an authorization code, by a financial institution having issued the bank card, comprising:
a keyboard for entering the authorization code; and
a remittance transfer unit connected to the keyboard, interposed between the merchant's smart card and the customer loyalty smart card and through which the remittance from the merchant's smart card is transferred to the customer loyalty smart card, wherein the remittance transfer unit comprises a remittance-to-authorization code associating means.

12. A remittance transfer system as defined in claim 11, wherein the bank card is one of the following cards:
a credit card;
a debit card; or
any other customer's card usable to complete a transaction between a merchant and the customer and requiring an authorization code from the financial institution having issued the card to approve the transaction.

13. A remittance transfer system as defined in claim 11, wherein:
the keyboard forms part of an electronic remittance transfer device; and
the electronic remittance transfer device further comprises:
a merchant's smart card receiving means having electric contacts for connection to external electric contacts of an integrated circuit of the merchant's smart card; and
a customer loyalty smart card receiving means having electric contacts for connection to external electric contacts of an integrated circuit of the customer loyalty smart card.

14. A remittance transfer system as defined in claim 11, wherein an amount of the transaction is entered through the keyboard, and said remittance transfer system further comprises, in the merchant's smart card, a calculator of an amount of the remittance in relation to the amount of the transaction, said calculator incorporating a predetermined remittance calculating function.

15. A remittance transfer system as defined in claim 14, wherein:
the customer loyalty smart card comprises a statistical remittance data memory in which statistical data about the remittances transferred to the customer loyalty smart card is stored; and
the electronic remittance transfer device comprises a statistics reader module for interposition between the remittance amount calculator and the statistical remittance data memory, wherein the remittance amount calculator consults the data about the remittances stored in the statistical remittance data memory through said statistics reader module.

16. A remittance transfer system as defined in claim 11, wherein:
an amount of the transaction is entered through the keyboard;
the merchant's smart card comprises a merchant's electronic wallet;
the customer loyalty smart card comprises a consumer's electronic wallet;
the remittance transfer unit comprises, between the merchant's electronic wallet and the consumer's electronic wallet, a remittance transfer module fulfilling the function of debiting the remittance from the merchant's electronic wallet and crediting said remittance to the customer's electronic wallet upon said transfer of the remittance; and
the merchant's smart card comprises a memory of an identification code of a merchant's payment terminal through which the transaction has been approved by the financial institution;
a storing circuit having access to given data related to each remittance and including a memory of said given data in the customer loyalty smart card, wherein said given data comprises:
the date and time of the remittance;
the identification code of the merchant's payment terminal;
the amount of the transaction;
the authorization code; and
the amount of the remittance.

17. A remittance transfer system as defined in claim 16, further comprising a communication network to recover and store in a remittance journal the data related to each remittance, stored in the customer loyalty smart card and including:
the date and time of the remittance;
the identification code of the merchant's payment terminal;
the amount of the transaction;
the authorization code; and
the amount of the remittance.

18. A remittance transfer system as defined in claim 17, further comprising:
a transaction journal storing, for each transaction:
the date and time of the transaction;
the identification code of the merchant's payment terminal;
the amount of the transaction; and
the authorization code; and
a data comparing computer connected to both the transaction and remittance journals and comparing the data related to the transactions stored in the transaction journal with the data related to the remittances stored in the remittance journal in view of detecting frauds.

19. A remittance transfer system as defined in claim 18, wherein the data comparing computer comprises:
a detector of a transaction having in the transaction and remittance journals the same authorization code and payment terminal identification code but different amounts of transaction; and
an indicator of either an error upon entering the amount of the transaction through the keyboard of the electronic remittance transfer device or an attempted fraud, activated by said detector upon detection of a transaction having in the transaction and remittance journals the same authorization code and payment terminal identification code but different amounts of transaction.
